(19) United States
(12) Patent Application Publication
(10) Pub. No.: US 2008/0136802 A1
(43) Pub. Date: Jun. 12, 2008

(54) Module operation information display system

(75) Inventors: Chih-Peng Chuang, Taipei (TW); Sheng-Tzu Yang, Taipei (TW); Chao-Yang Huang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/731,637

(22) Filed: Mar. 30, 2007

(30) Foreign Application Priority Data
Dec. 7, 2006 (TW) 095145586

(51) Int. Cl. G06F 3/038

(52) U.S. Cl. 345/205

(57) ABSTRACT

A module operation information display system is applicable to a data processing device having a plurality of functional modules and a first electrical connection unit electrically connected with the functional modules. The module operation information display system includes a second electrical connection unit electrically connectable with the first electrical connection unit; a controlling unit for acquiring module operation information of the functional modules; an identifying unit for identifying address and data of the module operation information; an input unit allowing a user to select one of the module operation information of one of the functional modules to be monitored; a programmable logic module for storing the identified address and data into a storage module and searching the storage module for the address and data according to a module name and a monitored item of the selected functional module; and a display module for displaying the module name, the monitored item and a value of the monitored item of the functional module.

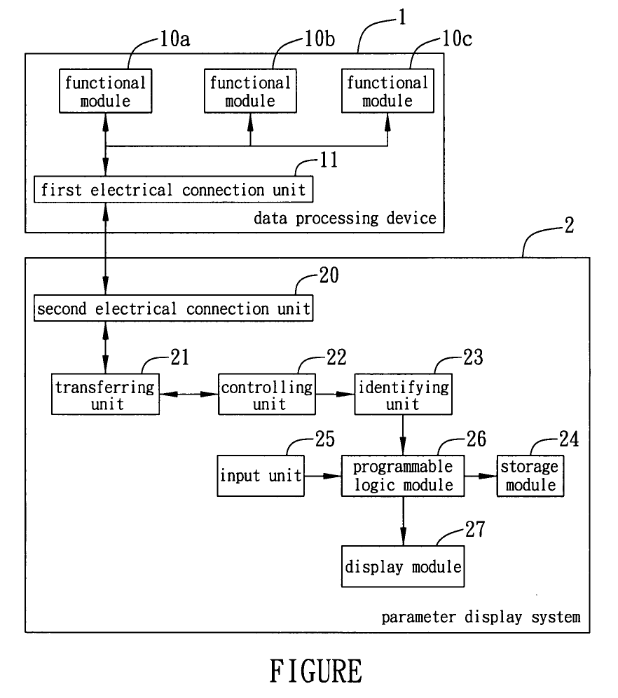

### BACKGROUND OF THE INVENTION

1. Field of the Invention

The present invention relates generally to a module operation information display systems, and more particularly, to a module operation information display system applied in a data processing device for monitoring module operation information thereof, wherein the data processing device having a plurality of functional modules and a first electrical connection unit electrically connected with the plurality of functional modules.

2. Description of Related Art

Data processing devices such as servers or vehicle computers are generally equipped with monitors such as LCDs or LCD modules for facilitating various operations such as maintenance.

However, most of the servers are controlled remotely, and a monitor of a server is installed for doing nothing but displaying module operation information, such as temperatures of a central processing unit (CPU) and a hard disk, and rotating speed of a fan. Moreover, if each server has to be equipped with a monitor for such the module operation information-displaying purpose, required monitors increase in number, and user will suffer from great burden of cost.

Therefore, there is a need to provide a portable module operation information display system capable of displaying various module operation information so as to decrease the cost.

### SUMMARY OF THE INVENTION

According to the above drawbacks, an objective of the present invention is to provide a portable module operation information display system capable of displaying various module operation information, thereby decreasing the cost.

In order to attain the above and other objectives, the present invention discloses a module operation information display system applicable to a data processing device having a plurality of functional modules and a first electrical connection unit electrically connected with the functional modules. The module operation information display system comprises: a second electrical connection unit corresponding to and electrically connectable with the first electrical connection unit; a controlling unit electrically connected with the second electrical connection unit, for acquiring module operation information of the functional modules through an electrical connection established between the second electrical connection unit and the first electrical connection unit, each of the module operation information comprising an address of one of the functional modules and data corresponding to the address, the data comprising a module name, a monitored item, and a value of the monitored item of the one of the functional modules; an identifying unit electrically connected with the controlling unit for identifying the addresses and the data of the module operation information acquired by the controlling unit; a storage module for storing the addresses and the data of the module operation information; an input unit allowing a user to select one of the module operation information of one of the functional modules to be monitored by inputting the module name and the monitored item of the one of the functional modules; a programmable logic module electrically connected with the identifying unit, the storage module and the input unit for storing the identified addresses and data identified by the identifying unit into the storage module and searching the storage module for the address and data according to the module name and monitored item selected by the user and inputted to the input unit; and a display module electrically connected with the programmable logic module for displaying the module name, the monitored item and the value of the monitored item of the functional module corresponding to the address found by the programmable logic module.

In a preferred embodiment, the functional modules include a CPU, a hard disk and a fan; the first electrical connection unit is a connector; the data process device is a computer or a server; the second electrical connection unit is a connector; the controlling unit is a microcontroller; the module operation information of the functional modules acquired by the controlling unit comprise a temperature of a CPU, another temperature of a hard disk, and a rotating speed of a fan; the identifying unit is a latch; the storage module comprises a ROM and a RAM; the input unit is an operating key; the programmable logic module is a complex programmable logic device; the display module is a liquid crystal display; a transferring unit is electrically connected between the second electrical connection unit and the controlling unit and functioning as a message communication medium between the second electrically connecting unit and the controlling unit, wherein the transferring unit is a bus controller.

Therefore, according to the module operation information display system of the present invention, the module operation information of a plurality of functional modules are acquired by a controlling unit and then identified by an identifying unit. Thereafter, the programmable logic module stores the identifying result in a storage module. When a user selects one of the module operation information of one of the functional modules to be monitored through an input unit, the programmable logic module searches the storage module for the corresponding address and data value such that a display module can display the module name, the monitored item and the value of the monitored item of the selected functional module. Thus, users can monitor various module operation information through the module operation information display system of the present invention, thereby decreasing the cost.

### BRIEF DESCRIPTION OF DRAWINGS

FIGURE is a block diagram of a data processing device and a module operation information display system according to the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be made without departing from the spirit of the present invention.

FIGURE is a block diagram of a data processing device 1 and a module operation information display system 2 of an embodiment according to the present invention. The module operation information display system 2 is applied in the data processing device 1. The data processing device 1 comprises a plurality of functional modules 10a, 10b and 10c, and a first electrical connection unit 11 electrically connected with the functional modules 10a, 10b and 10c. In the present embodiment, the data processing device 1 is a computer or a server, the functional modules 10a, 10b and 10c are a CPU, a hard disk and a fan respectively, and the first electrical connection unit 11 is a connector. The module operation information display system 2 comprises a second electrical connection unit 20, a transferring unit 21, a controlling unit 22, an identifying unit 23, a storage module 24, an input unit 25, a programmable logic module 26 and a display module 27.

The second electrical connection unit 20 corresponds to the first electrical connection unit 11 and is electrically connectable with the first electrical connection unit 11. In the present embodiment, if the first electrical connection unit 11 is a male connector, the second electrical connection unit 11 is a female connector, or vice versa.

The transferring unit 21 is electrically connected with the second electrical connection unit 20 and the controlling unit 22. The transferring unit 21 is used as a message communication medium between the second electrical connection unit 20 and the controlling unit 22. In the present embodiment, message communication between the transferring unit 21 and the second electrically connecting unit 20 is implemented through an I2C bus, or an SMBus that is not supported by the controlling unit 22. Therefore, the transferring unit 21 functions as a message communication medium between the second electrical connection unit 20 and the controlling unit 22 such that the controlling unit 22 can read messages transferred from the second electrical connecting unit 20. The transferring unit 21 can be an I2C bus controller such as PCA9564.

The controlling unit 22 is electrically connected via the first electrical connection unit 21 with the second electrical connection unit 20, for acquiring module operation information of the functional modules 10a, 10b and 10c (that is the CPU, the hard disk and the fan). Each of the module operation information comprises an address corresponding to one of the functional modules 10a, 10b and 10c, and data corresponding to the address. In the present embodiment, the controlling unit 22 is a microcontroller, and the data corresponding to the address of each of the module operation information of the functional modules 10a, 10b and 10c comprise a module name, a variety of monitored items, such as a monitored item of temperature and another monitored item of voltage level for the CPU (the functional module 10a), another monitored item of temperature for the hard disk (the functional module 10b), and a monitored item of rotating speed for the fan (the functional module 10c), and a plurality of values corresponding to the monitored items, such as a temperature, a voltage level and a rotating speed.

The identifying unit 23 is electrically connected with the controlling unit 22. The identifying unit 23 is used for identifying the addresses and the data of the module operation information acquired by the controlling unit 22. In the present embodiment, the identifying unit 23 identifies the addresses and the data of the CPU, hard disk and fan, and the values of the data comprise the temperature and voltage level of the CPU, the temperature of the hard disk, and the rotating speed of the fan. The identifying unit 23 is a latch, which bears a decoding function for identifying the addresses and the data. The latch is well-known in the art, further description hereby omitted.

The storage module 24 is used to store data. In the present embodiment, the storage module 24 comprises a ROM and a RAM.

The input unit 25 is used for a user to select one of the functional module 10a, 10b and 10c that the user is going to monitor by inputting the module name and the monitored item of the one of the function module 10a, 10b and 10c. For instance, if the user is going to monitor the temperature of the CPU, the user is allowed to input to the input unit 25 the module name of the CPU, and the monitored item of temperature. In the present embodiment, the input unit 25 is an operating key.

The programmable logic module 26 is electrically connected with the identifying unit 23, the storage module 24 and the input unit 25, for storing the identified address and data identified by the identifying unit 23 into the storage module 24 and searching the storage module 24 for an address and data corresponding to the address based on the module name and monitored item selected by the user and input to the input unit 25. For example, according to the scenario described above, as the user inputs the module name of the CPU and the monitored item temperature, the identifying module 26 searches the storage module 24 for an address and the temperature of the CPU. In the present embodiment, the programmable logic module 26 is a complex programmable logic device.

The display module 27 is electrically connected with the programmable logic module 26, for displaying the module name and the monitored item selected by the user and input to the input unit 25 for the use's reference, and the value corresponding to the monitored item. For instance, the display module 27 displays the module name of CPU, the monitored item of temperature, and the value of the temperature of the CPU. In the present embodiment, the display module 27 is a liquid crystal display.

Therefore, according to the module operation information display system of the present invention, the module operation information of a plurality of functional modules are acquired by a controlling unit and then identified by an identifying unit. Thereafter, the programmable logic module stores the identifying result in a storage module. When a user selects module operation information of a functional module to be monitored through an input unit, the programmable logic module searches the storage module for the corresponding address and data such that a display module can display a module name, a monitored item, and a value of the monitored item of the functional module. Thus, the user can monitor various kinds of module operation information of the data processing device such as the temperature and voltage level of the CPU, the temperature of the hard disk, and the rotating speed of the fan. Compared with the prior art that requires several special monitors for monitoring various module operation information, the present invention decreases the cost.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A module operation information display system applicable to a data processing device having a plurality of functional modules and a first electrical connection unit electrically connected with the functional modules, the module operation information display system comprising:
a second electrical connection unit corresponding to and electrically connectable with the first electrical connection unit;
a controlling unit electrically connected with the second electrical connection unit for acquiring module operation information of the functional modules through an electrical connection established between the second electrical connection unit and the first electrical connection unit, each of the module operation information comprising an address of one of the functional modules and data corresponding to the address, the data comprising a module name, a monitored item, and a value of the monitored item of the one of the functional modules;
an identifying unit electrically connected with the controlling unit for identifying the addresses and the data of the module operation information acquired by the controlling unit;
a storage module for storing the addresses and the data of the module operation information;
an input unit allowing a user to select one of the module operation information of one of the functional modules to be monitored by inputting the module name and the monitored item of the one of the functional modules;
a programmable logic module electrically connected with the identifying unit, the storage module and the input unit for storing the identified addresses and data identified by the identifying unit into the storage module and searching the storage module for the address and data according to the module name and monitored item selected by the user and inputted to the input unit; and
a display module electrically connected with the programmable logic module for displaying the module name, the monitored item and the value of the monitored item of the functional module corresponding to the address found by the programmable logic module.

2. The system of claim 1, wherein the functional modules comprise a central processing unit (CPU), a hard disk and a fan.

3. The system of claim 1, wherein the first electrical connection unit is a connector.

4. The system of claim 1, wherein the data processing device is one of a computer and a server.

5. The system of claim 1, wherein the second electrical connection unit is a connector.

6. The system of claim 1, wherein the controlling unit is a microcontroller.

7. The system of claim 1, wherein the module operation information of the functional modules acquired by the controlling unit comprise a temperature of a CPU, another temperature of a hard disk and a rotating speed of a fan.

8. The system of claim 1, wherein the identifying unit is a latch.

9. The system of claim 1, wherein the storage module comprises a read only memory (ROM) and a random access memory (RAM).

10. The system of claim 1, wherein the input unit is an operating key.

11. The system of claim 1, wherein the programmable logic module is a complex programmable logic device.

12. The system of claim 1, wherein the display module is a liquid crystal display (LCD).

13. The system of claim 1, wherein a transferring unit is electrically connected between the second electrical connection unit and the controlling unit, the transferring unit functioning as a message communication medium between the second electrical connection unit and the controlling unit.

14. The system of claim 13, wherein the transferring unit is an I2C bus controller.
